(19) United States
(12) Patent Application Publication
(10) Pub. No.: US 2006/0088768 A1
(43) Pub. Date: Apr. 27, 2006

(54) Electrode structure of lithium battery

(76) Inventor: Jang Chung Fang, Taipei (TW)

Correspondence Address: LEONG C LEI, PMB # 1008, 1867 YGNACIO VALLEY ROAD, WALNUT CREEK, CA, 94598, US

(21) Appl. No.: 10/972,570

(22) Filed: Oct. 25, 2004

(51) Int. Cl. H01M 4/70; H01M 4/58

(52) U.S. Cl. 429/241; 429/233; 429/231.95; 429/221; 429/231.5; 429/223

(57) ABSTRACT

The present invention discloses an electrode structure of lithium battery that comprises a plurality of holes. More participating lithium compounds can be attached on the plurality of holes and less matter adhesive is required at the electrode. Hence the energy density of lithium battery is raised.

### BACKGROUND OF THE INVENTION

1. Field of the Invention

The present invention generally relates to electrode structure of battery, and more particularly to electrode structure of lithium battery.

2. Description op the Prior Art

The applications of battery are widely broaden day after day, especially in the explosive developing consumer electronics, such as walkman, PDA (personal digital assistant), digital camera, and etc. A large part of these battery applications takes advantage of lithium electric chemical reactions to produce potential electric voltage. The type of mentioned battery is usually named as lithium battery.

Please refer to FIG. 1, which shows a conventional lithium battery module 100. The lithium battery module 100 comprises a separating structure 110, a positive electrode structure 120, a negative electrode structure 130, and an anolyte 140. In this regards, the positive electrode structure 120 and the negative electrode structure 130 are located at the different sides of the separating structure 110. Besides, the anolyte 140 which flows freely through the separating structure 110 are filled with the positive electrode structure 120 and the negative electrode structure 130. As shown in FIG. 1, the positive electrode structure 120 further comprises a positive electrode fixation structure 122 and a positive electrode matter 124 which is attached on the positive electrode fixation structure 122. In this regards, the materials of the positive electrode fixation structure 122 comprises aluminum. Furthermore, the positive electrode fixation structure 122 may comprise an aluminum foil and/or aluminum net. Besides, the positive electrode matter 124 comprises chemical compound containing lithium and positive electrode matter adhesive. The mentioned chemical compound containing lithium may comprise compound containing lithium and cobalt, compound containing lithium and manganese, compound containing lithium, iron, and phosphorous, compound containing lithium, vanadium, and phosphorous, compound containing lithium and nickel, derivatives containing lithium and nickel (modified with manganese, aluminum, and magnesium), and any other chemical compound containing lithium which involved in an electric chemical reaction. Most of the chemical compound containing lithium is made as powder, which can be attached to the positive electrode fixation structure 122 by the help of the positive electrode matter adhesive 124.

As shown in the FIG. 1, the negative electrode structure 130 further comprises a negative electrode fixation structure 132 and a negative electrode matter 134 which is attached to the negative electrode fixation structure 132. In this regards, the material of the negative electrode fixation structure 132 comprises copper. Furthermore, the negative electrode fixation structure 132 comprises a copper foil and/or a copper net. The negative electrode matter 134 comprises carbon and negative electrode matter adhesive. Besides, the separating structure 110 comprises a separating membrane. The size of holes of the separating structure 110 is large enough to allow the passages of lithium ions within the anolyte 140 between the positive electrode structure 120 and the negative electrode structure 130.

During the discharge process in the lithium battery module 100, the lithium ions within the positive electrode matter 124 goes to the negative electrode structure 130 through the separating structure 110 shown in the FIG. 1. In the contrary, during the charge process in the lithium battery module 100, the lithium ions in the negative electrode structure 130 goes to the positive electrode structure 120 through the separating structure 110. Hence, the energy density is dependent on the number of the lithium ions within the positive electrode matter 124. However, in the volume occupied by the positive electrode structure 120, some portion of the volume is occupied by the positive electrode matter adhesive. If the ratio of the positive electrode matter adhesive in the positive electrode matter 124 can be reduced, the ratio of the chemical compound containing lithium in the positive electrode matter 124 can be raised in the contrary. In the consequence, the energy density of this lithium battery module 100 can be prompted.

Please refer to FIG. 2, which depicts an enlarged diagram of the positive electrode structure 120 in the FIG. 1. The depicted positive electrode fixation structure 124 is a smooth-surfaced aluminum foil, as shown in FIG. 2. The mentioned chemical compound containing lithium could be attached on the aluminum foil with the help of the positive electrode matter adhesive.

In summary, it is desired to increase the energy density of battery in the same volume.

### SUMMARY OF THE INVENTION

According to the background descriptions, the desire of increasing the energy density of battery, the present invention provides an electrode structure of battery to achieve the improvements over the prior art.

An objective of the present invention is to provide an electrode structure which comprises a positive electrode fixation structure and a positive electrode matter. In this regards, the positive electrode matter further comprises chemical compound containing lithium and positive electrode matter adhesive. The positive electrode fixation structure comprises a plurality of holes. More chemical compound containing lithium can be attached to the positive electrode fixation structure by the help of the plurality of holes. Hence, the ratio of positive electrode matter adhesive which does not participate in the electric chemical reaction can be reduced. In the consequence, the energy density of battery is increased.

### BRIEF DESCRIPTION OF THE DRAWINGS

The accompanying drawings incorporated in and forming a part of the specification illustrate several aspects of the present invention, and together with the description serve to explain the principles of the invention. In the drawings:

FIG. 1 shows a diagram illustrating a conventional lithium battery module;

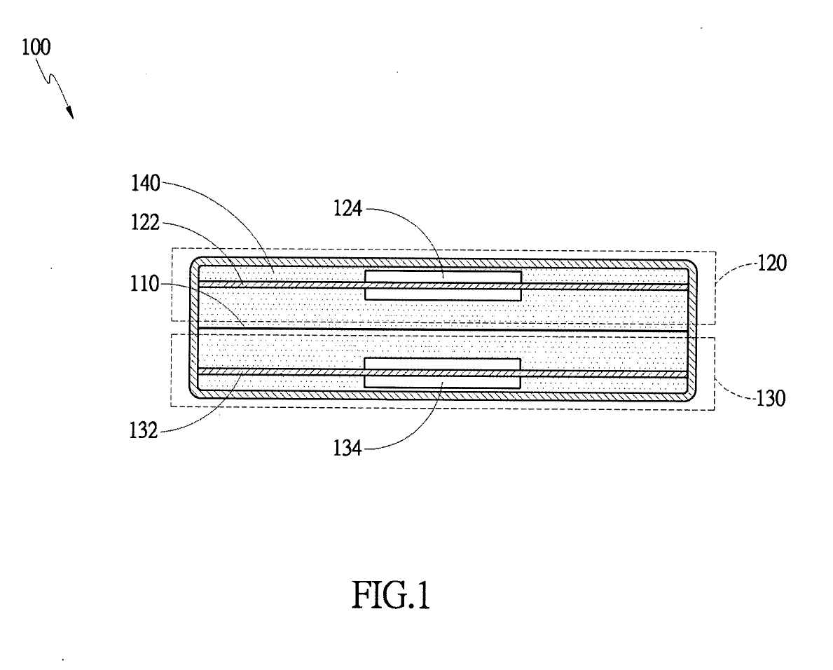

FIG. 2 depicts a enlarged diagram illustrating a positive electrode structure shown in the FIG. 1; and

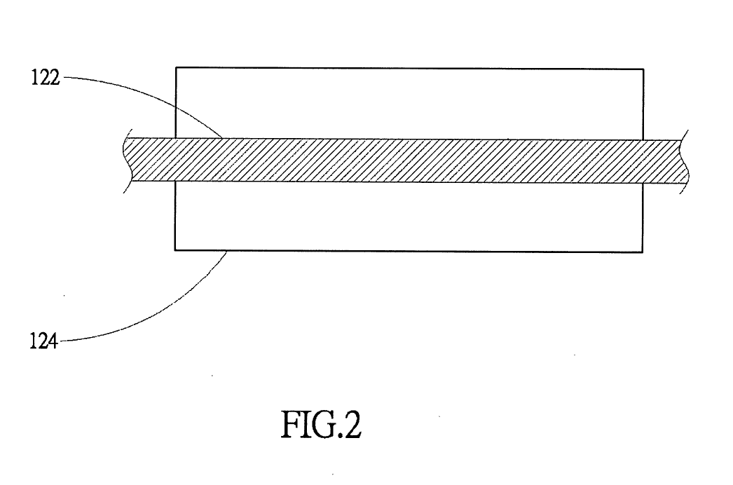

FIG. 3 shows a diagram representing a positive electrode structure in accordance with an embodiment of the present invention.

### DESCRIPTION OF THE PREFERRED EMBODIMENT(S)

Having summarized various aspects of the present invention, reference will now be made in detail to the description of the invention as illustrated in the drawings. While the invention will be described in connection with these drawings, there is no intent to limit it to the embodiment or embodiments disclosed therein. On the contrary the intent is to cover all alternatives, modifications and equivalents included within the spirit and scope of the invention as defined by the appended claims.

It is noted that the drawings presents herein have been provided to illustrate certain features and aspects of embodiments of the invention. It will be appreciated from the description provided herein that a variety of alternative embodiments and implementations may be realized, consistent with the scope and spirit of the present invention.

It is also noted that the drawings presents herein are not consistent with the same scale. Some scales of some components are not proportional to the scales of other components in order to provide comprehensive descriptions and emphasizes to this present invention.

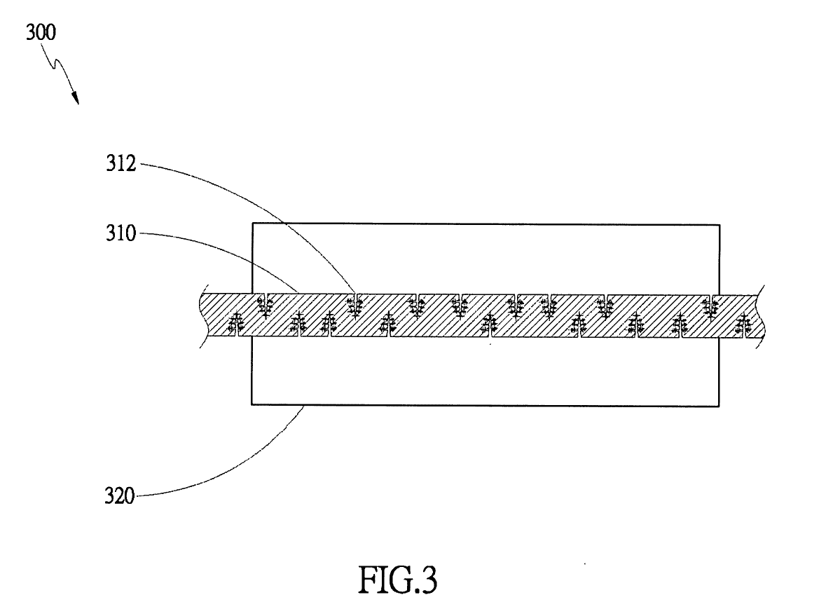

Please refer to FIG. 3, which depicts a diagram of a positive electrode structure 300 of a lithium battery in accordance with an embodiment of the present invention. The positive electrode structure 300 comprises a positive electrode fixation structure 310 and a positive electrode matter 320. In this regards, the positive electrode fixation structure 310 comprises an etched aluminum foil which is etched by the electrical discharge machining. The etched aluminum foil is applied broadly at the passive electrical components such as capacitors. In addition, the electrical discharge machining is a well-known technique which will not be discussed in the present invention. As shown in the FIG. 3, the positive electrode fixation structure 310 comprises a plurality of holes 312, which looks like tree branches or so-called fractal. An important feature of the holes 312 is that it comprises a tremendous surface area. Besides, no matter whether the holes 312 penetrate the etched aluminum foil, they are in accordance with the present invention.

Referring to the mentioned description, the positive electrode matter 320 of the lithium battery comprises a chemical compound containing lithium and a positive electrode matter adhesive. In this regards, the chemical compound containing lithium comprises compound containing lithium and cobalt, compound containing lithium and manganese, compound containing lithium, iron, and phosphorous, compound containing lithium, vanadium, and phosphorous, compound containing lithium and nickel, derivatives containing lithium and nickel (modified with manganese, aluminum, and magnesium), and any other chemical compound containing lithium which can involve an electric chemical reaction. In addition, the chemical compound containing lithium is made as powder, which grain size may be measured in several nano-meters. It is very difficult to attach the powder in such fine-grained on the aluminum foil and/or net of the positive electrode fixation structure in the prior art. This means more positive electrode matter adhesive is needed to attach the chemical compound containing lithium; hence the energy density can not be raised. In the present invention, since the plurality of holes 312 has tremendous surface area, the etched aluminum foil provides more adhesion than the conventional smooth-surfaced aluminum foil and/or net. In the consequence, the ratio of the positive electrode matter adhesive in the positive electrode matter can be decreased; the ratio of chemical compound containing lithium can be increased. Accordingly, in the same volume, the positive electrode fixation structure 310 in accordance with the present invention provides larger energy density.

The foregoing description is not intended to be exhaustive or to limit the invention to the precise forms disclosed. Obvious modifications or variations are possible in light of the above teachings. In this regard, the embodiment or embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the inventions as determined by the appended claims when interpreted in accordance with the breath to which they are fairly and legally entitled.

What is claimed is:

1. An electrode structure of battery, wherein said electrode structure comprises an electrode fixation structure and an electrode matter, and said electrode fixation structure further comprises a plurality of holes.

2. The electrode structure of battery of claim 1, wherein said plurality of holes is made by electrical discharge machining.

3. The electrode structure of battery of claim 1, wherein said plurality of holes penetrates said electrode fixation structure.

4. The electrode structure of battery of claim 1, wherein said plurality of holes does not penetrate said electrode fixation structure.

5. The electrode structure of battery of claim 1, wherein the material of said electrode fixation structure comprises aluminum.

6. The electrode structure of battery of claim 1, wherein the material of said electrode matter comprises chemical compound containing lithium and cobalt.

7. The electrode structure of battery of claim 1, wherein the material of said electrode matter comprises chemical compound containing lithium and manganese.

8. The electrode structure of battery of claim 1, wherein the material of said electrode matter comprises chemical compound containing lithium and phosphorous.

9. The electrode structure of battery of claim 1, wherein the material of said electrode matter comprises chemical compound containing lithium, iron, and phosphorous.

10. The electrode structure of battery of claim 1, wherein the material of said electrode matter comprises chemical compound containing lithium and nickel.

11. The electrode structure of battery of claim 1, wherein the material of said electrode matter comprises chemical compound containing lithium, vanadium, and phosphorous.

12. The electrode structure of battery of claim 10, wherein said chemical compound containing lithium and nickel comprises derivatives containing lithium and nickel modified with manganese.

13. The electrode structure of battery of claim 10, wherein said chemical compound containing lithium and nickel comprises derivatives containing lithium and nickel modified with aluminum.

14. The electrode structure of battery of claim 10, wherein said chemical compound containing lithium and nickel comprises derivatives containing lithium and nickel modified with magnesium.

15. The electrode structure of battery of claim 1, wherein said electrode structure is positive electrode structure.
